(19) United States
(12) Patent Application Publication
(10) Pub. No.: US 2026/0086481 A1
(43) Pub. Date: Mar. 26, 2026

(54) MULTI-PAGE CIRCULATING DUPLEX PRINTING METHOD

(71) Applicant: AVISION INC., Hsinchu (TW)

(72) Inventors: KE LIANG CHOU, Hsinchu City (TW); MIN TUNG HUANG, Hsinchu City (TW)

(21) Appl. No.: 19/311,202

(22) Filed: Aug. 27, 2025

(30) Foreign Application Priority Data
Sep. 26, 2024 (TW) 113136636

(51) Int. Cl. G03G 15/23; G03G 15/01; G06K 15/16

(52) U.S. Cl. CPC G03G 15/234; G03G 15/0194; G06K 15/16

(57) ABSTRACT

A printing method includes: printing a front side of a first document, and then transporting, from a first passage, the first document partially out and back to a reverse passage; printing a front side of a second document, and then transporting, from a second passage, the second document partially out and back to the reverse passage; printing a front side of a third document, and then transporting, from the first passage, the third document partially out and back to the reverse passage; printing a reverse side of the first document, and then transporting, from the second passage, the first document to a discharge tray; printing a reverse side of the second document, and then transporting, from the second passage, the second document to the discharge tray; and printing a reverse side of the third document, and then transporting, from the second passage, the third document to the discharge tray.

### CROSS-REFERENCE TO RELATED APPLICATIONS

This application claims priority of No. 113136636 filed in Taiwan R.O.C. on September 26, 2024 under 35 USC 119, the entire content of which is hereby incorporated by reference.

### FIELD OF THE INVENTION

This disclosure relates to a multi-page circulating duplex printing method, and more particularly to a multi-page circulating duplex printing method for optimizing transporting paths of a duplex printer.

### DESCRIPTION OF RELATED ART

Currently, a laser printer needs to flip a document at least twice, when performing duplex document printing, to maintain the order of the printed documents. For example, after printing a first side of the document, the document needs to be temporarily transported out, and then into a flipping passage, in which a first flip is performed, and then a second side of the document can be printed, and the document can be transported to a discharge tray. The printing speed of the printer can be expressed in pages per minute (PPM) or images per minute (IPM). Duplex printers can also perform single-sided printing. In general, the duplex printer with a single-sided printing speed of up to 30 PPM will theoretically have a printing speed of up to 30 IPM when performing single-sided printing. However, when performing duplex printing, the actual speed is often less than 15 IPM due to the need for paper flipping in the path; for example, the actual speed may only reach 12 IPM or even lower.

US2022/0314643A1 discloses a multi-function peripheral with a pivoting flipping guide mechanism, but does not further disclose improvements to the printing speed. Therefore, how to improve the duplex printing speed of a duplex printer is the problem to be solved by this disclosure.

### SUMMARY OF THE INVENTION

It is therefore an objective of this disclosure to provide a multi-page circulating duplex printing method that optimizes transporting paths of a duplex printer to increase the duplex printing speed.

To achieve the above-identified objective, this disclosure provides a multi-page circulating duplex printing method used in a duplex printer. The multi-page circulating duplex printing method includes steps of: printing a front side of a first document using a printing unit, and then transporting, from a first passage, the first document partially out and then back to a reverse passage; printing a front side of a second document using the printing unit, and then transporting, from a second passage, the second document partially out and then back to the reverse passage; printing a front side of a third document using the printing unit, and then transporting, from the first passage, the third document partially out and then back to the reverse passage; printing a reverse side of the first document using the printing unit, and then transporting, from the second passage, the first document to a discharge tray; printing a reverse side of the second document using the printing unit, and then transporting, from the second passage, the second document to the discharge tray; and printing a reverse side of the third document using the printing unit, and then transporting, from the second passage, the third document to the discharge tray.

With the above-mentioned embodiment and in conjunction with controlling timings of printing, transporting out and transporting back based on a passage length, the waiting time can be shortened and the duplex printing speed can be increased.

In order to make the above-mentioned content of this disclosure more obvious and be easily understood, preferred embodiments will be described in detail as follows in conjunction with the accompanying drawings.

### BRIEF DESCRIPTION OF DRAWINGS

FIG. 1 is a schematic block diagram showing a duplex printer according to a preferred embodiment of this disclosure.

FIG. 2 is a schematic view showing the duplex printer of FIG. 1.

FIG. 3 is a schematic view showing timings of a multi-page circulating duplex printing method according to the preferred embodiment of this disclosure.

FIG. 4 is a flow chart showing the multi-page circulating duplex printing method of FIG. 3.

FIG. 5 is a flow chart showing a modified example of the multi-page circulating duplex printing method of FIG. 4.

FIG. 6 is a flow chart showing another modified example of the multi-page circulating duplex printing method of FIG. 4.

### DETAILED DESCRIPTION OF THE INVENTION

In this disclosure, path configurations of the duplex printer are mainly utilized to print multiple documents as a group. Preferably, multiple documents are simultaneously present within the sheet passages of the duplex printer with appropriate spacing(s) between the multiple documents to prevent the documents from collision in the sheet passages and to increase the printing speed. Although the following explanations are made according to a laser printer serving as an example, this disclosure is not restricted thereto.

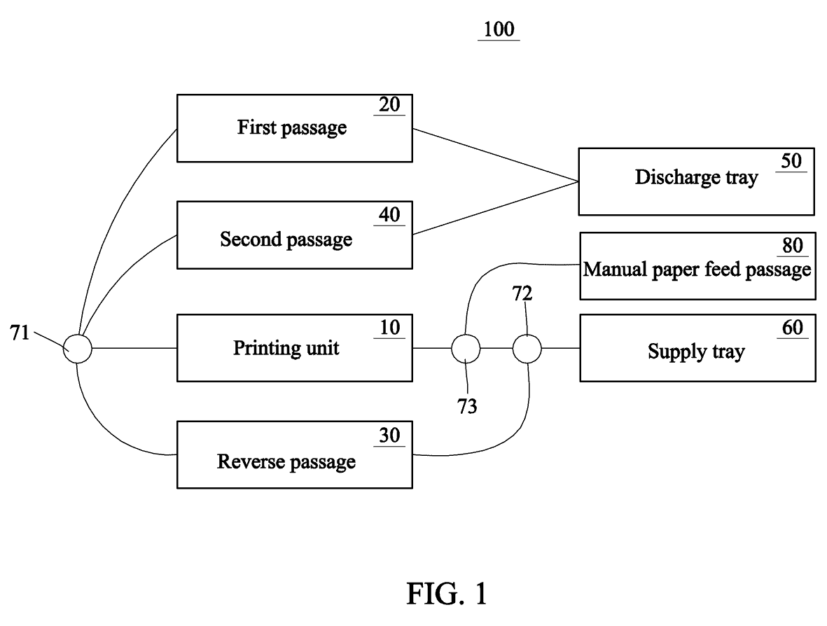

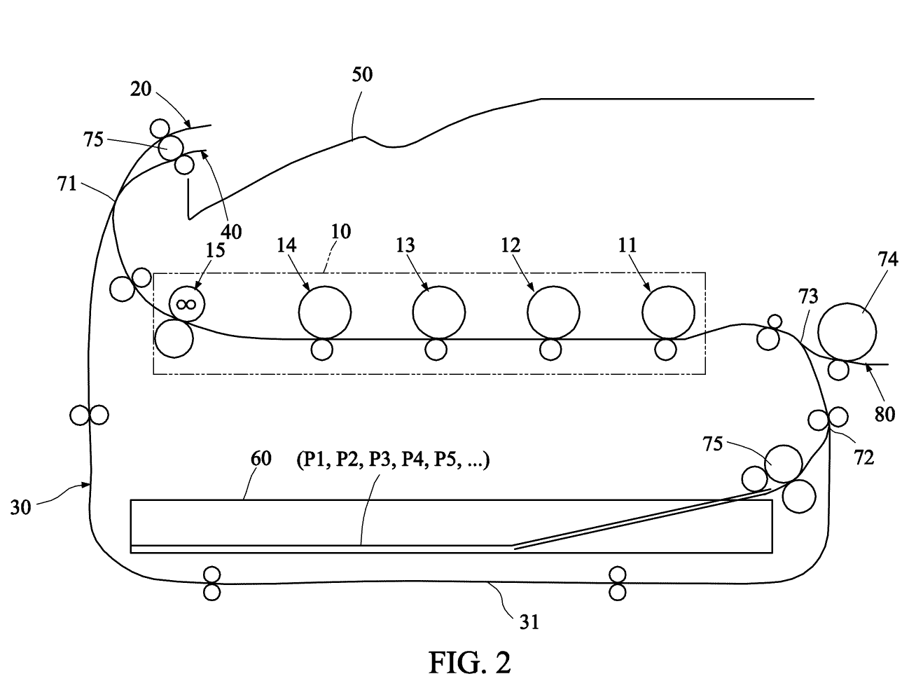

FIG. 1 is a schematic block diagram showing a duplex printer 100 according to a preferred embodiment of this disclosure. FIG. 2 is a schematic view showing the duplex printer 100 of FIG. 1. Referring to FIGS. 1 and 2, the duplex printer 100 includes a printing unit 10 (having a corresponding printing passage), a first passage 20, a reverse passage 30, a second passage 40, a discharge tray 50 and a supply tray 60. The supply tray 60 stores documents or sheets (e.g., P1 to P5), and the printing unit 10 performs printing operations of the documents. In this example, the printing unit 10 includes C (cyan), M (magenta), Y (yellow), K (black) imaging and developing modules 11, 12, 13 and 14 and a fixation module 15, wherein the details thereof are well known in the art, and will not be described in detailed herein. Briefly, these modules incorporate standard components such as photosensitive drums, toner reservoirs and developer rollers, heater rollers and pressure rollers, all operating according to established principles within the laser printer art. The printing unit 10 is connected to the first passage 20, the second passage 40 and the reverse passage 30 through an intersection 71. The printing unit 10 is connected to the reverse passage 30 and the supply tray 60 through intersections 73 and 72. A manual paper feed passage 80 is connected to the printing unit 10 through the intersection 73, so that the user can manually insert or place a sheet to be fed, by a feeding roller 74, to the printing unit 10 that prints data on the sheet. In this example, the first passage 20 is disposed above the second passage 40, and is also referred to as an upper passage, whereas the second passage 40 is referred to as a lower passage. An active and/or passive switching mechanism may be disposed at the intersection 71, wherein details of a non-restrictive example may be found in US2022/0314643A1, and will not be described herein.

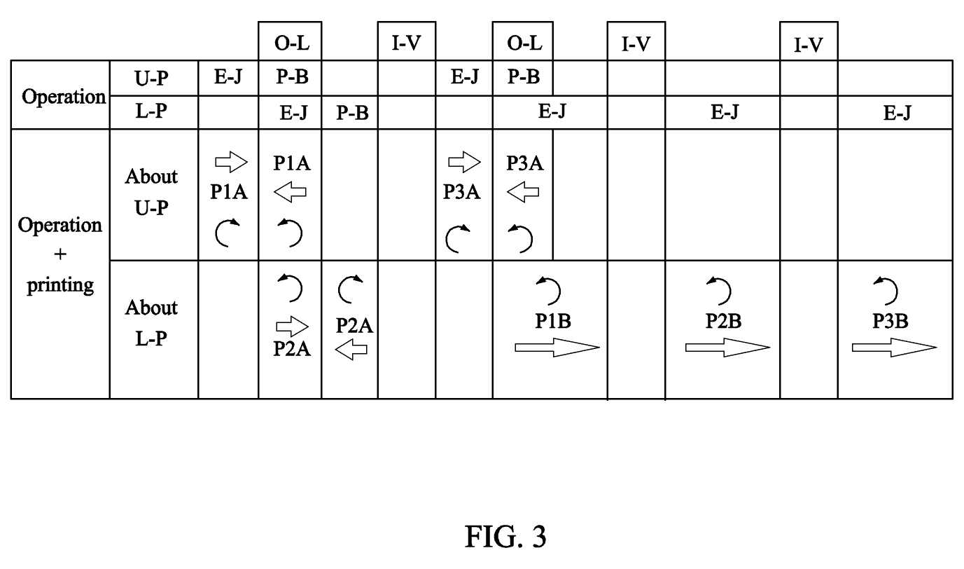

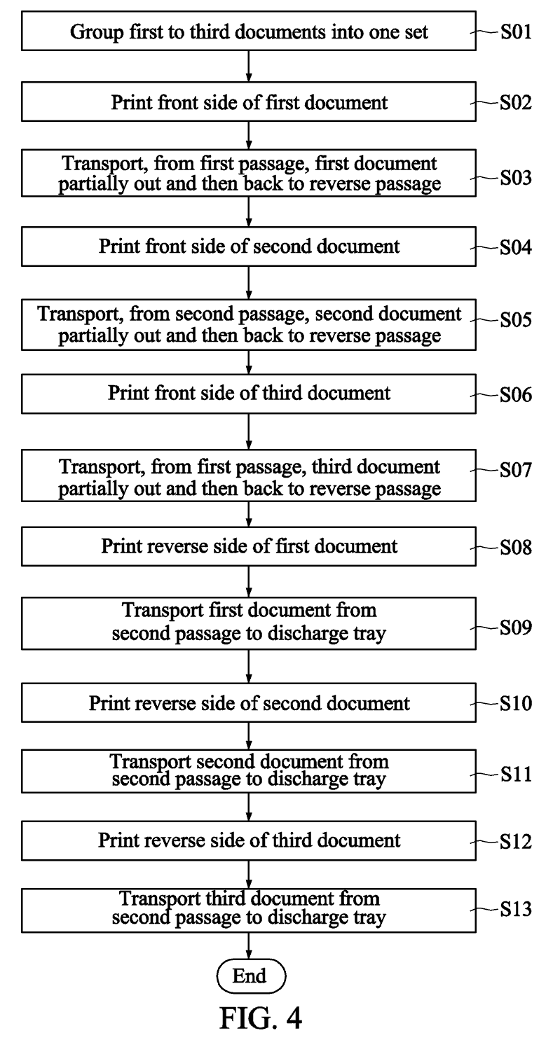

FIG. 3 is a schematic view showing timings of a multi-page circulating duplex printing method according to the preferred embodiment of this disclosure, wherein symbols in clockwise and counterclockwise directions represent rotating directions of an intermediate roller 75, a rightward hollow arrow represents that the intermediate roller 75 transports the document out (ejecting, denoted by E-J in FIG. 3), and a leftward hollow arrow represents that the intermediate roller 75 transports the document back (pulling back, denoted by P-B in FIG. 3). FIG. 4 is a flow chart showing the multi-page circulating duplex printing method of FIG. 3. Referring to FIGS. 1 to 4, the multi-page circulating duplex printing method used in the duplex printer 100 includes steps S01 to S13. It is to be noted that the upper passage and the lower passage are denoted by U-P and L-P in FIG. 3.

First in the step S01, after a processor (not shown) of the duplex printer 100 has received a print signal, the processor determines print information represented by the print signal. For simplicity, the print information in this example represents printing of three pages of duplex printing documents. The processor groups the first document P1 to the third document P3 into one set, and performs a three-page circulating duplex print operation, which is to print six pages of images. In another example, the print information represents printing of less than three pages of duplex printing documents, and does not perform the printing method of this disclosure. In still another example, the print information represents printing of more than three pages of duplex printing documents, in which the printing method of this disclosure is performed, and another or other additional printing methods are performed. Thus, the processor prints a total number of print documents corresponding to the print signal in a manner of grouping three ones of the print documents into one set. For example, the first to third documents are grouped into a first set, the fourth to sixth documents are grouped into a second set, and so on.

In the step S02, the printing unit 10 prints (or prints data on) a front side P1A of the first document P1. Then, in the step S03, the first document P1 is transported, from the first passage 20, partially out and then back to the reverse passage 30. The transporting process can be performed by rollers shown in FIG. 2. It is understandable that the operation of transporting the document partially out and then back represents that the document does not leave the intermediate roller 75, which means that the document is nipped or clamped between the intermediate roller 75 and the adjacent roller.

In the step S04, the printing unit 10 prints a front side P2A of the second document P2. Then, in the step S05, the second document P2 is transported, from the second passage 40, partially out and then back to the reverse passage 30.

In the step S06, the printing unit 10 prints a front side P3A of the third document P3. Then, in the step S07, the third document P3 is transported, from the first passage 20, partially out and then back to the reverse passage 30.

In the step S08, the printing unit 10 prints a reverse side P1B of the first document P1. Then, in the step S09, the first document P1 is transported from the second passage 40 to the discharge tray 50.

In the step S10, the printing unit 10 prints a reverse side P2B of the second document P2. Then, in the step S11, the second document P2 is transported from the second passage 40 to the discharge tray 50.

In the step S12, the printing unit 10 prints a reverse side P3B of the third document P3. Then, in the step S13, the third document P3 is transported from the second passage 40 to the discharge tray 50. Heretofore, three documents each having two sides printed have been finished, so the printing ends (the printer enters an idle state to wait for another print task).

In this example, a timing of transporting the first document P1 back to the second passage 40 overlaps (or interleaves) with a timing of transporting the second document P2 to the reverse passage 30, wherein "overlap" is denoted by "O-L" in FIG. 3. In addition, a timing of transporting the third document P3 back to the reverse passage 30 overlaps (or interleaves) with a timing of transporting the first document P1 to the discharge tray 50. The above-mentioned overlap may be partial or complete. Therefore, the waiting time can be shortened, and the duplex printing speed can be increased. It is understandable that it is possible to configure the timings without overlap to ensure that the documents do not collide with one another.

In addition, to prevent document collisions in the passage, a first interval (time interval) is present between the timing of transporting the second document P2 back to the reverse passage 30 and the timing of transporting, from the first passage 20, to the third document P3 (temporarily to a position above the discharge tray 50), a second interval is present between the timing of transporting the first document P1 to the discharge tray 50 and the timing of transporting the second document P2 to the discharge tray 50, and a third interval is present between the timing of transporting the second document P2 to the discharge tray 50 and the timing of transporting the third document P3 to the discharge tray 50, wherein "interval" is denoted by "I-V" in FIG. 3. According to the information of the passage lengths and the intersections, the first interval to the third interval may be designed to be equal or unequal, but the invention is not restricted thereto.

In order to optimize the utilization of the total length of the passages, the design can be configured such that the first document P1, the second document P2 and the third document P3 are concurrently present (partially or completely), within a time period, in a print passage, including the first passage 20, the second passage 40 and the reverse passage 30, other than the supply tray 60 of the duplex printer 100, thereby increasing the printing speed. In one example, the total length of the other passages exclusive of the manual paper feed passage 80 ranges from 1,000 to 1,200 mm, wherein the length of each A4-sized document equals 297 mm, and the gap between the adjacent documents equals 50 mm, so that the length of the passages occupied equals 991 (=297×3+50×2) mm. This demonstrates that such the design is feasible, and the optimized printing speed can be achieved by adjusting the transporting and processing timings. Because the color duplex printer requires the longer print passage, this property can be utilized to implement a multi-page circulating duplex printing method, thereby increasing the printing speed. In addition, a portion 31 of the reverse passage 30 may be disposed above the supply tray 60. However, when there is a need to increase the passage length, the portion 31 may be disposed under the supply tray 60, as shown in FIG. 2. When the supply tray 60 is pulled out, the reverse passage 30 is temporarily broken. So, when a paper jam occurs at the portion 31, it is also beneficial for the user to pull out the supply tray 60 to remove the jammed paper. Of course, the multi-page circulating duplex printing method can be applied to not only the color duplex printer but also any printer having the appropriate passage length. For example, monochrome and color duplex printers may share the same casing, and thus have the same passage length to be utilized.

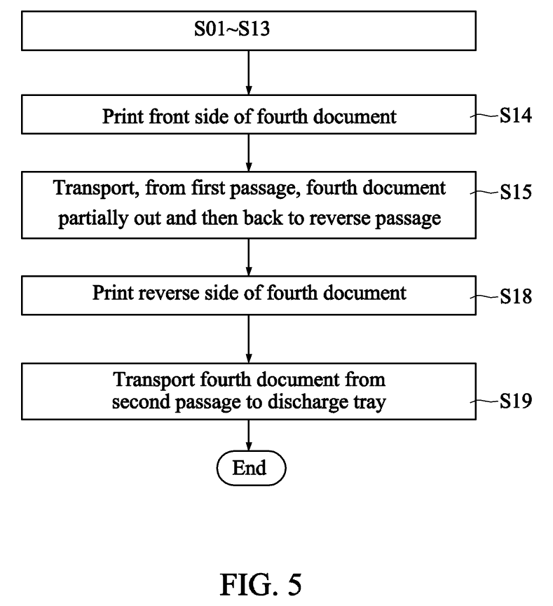

FIG. 5 is a flow chart showing a modified example of the multi-page circulating duplex printing method of FIG. 4. There is a fourth document remained after the step S01, in which the first to third documents are grouped as one set. In this case, the method further includes steps S14, S15, S18 and S19 after the third document P3 has been transported to the discharge tray 50.

In the step S14, the printing unit 10 prints a front side of the fourth document P4. Then, in the step S15, the fourth document P4 is transported, from the first passage 20, partially out and then back to the reverse passage 30.

In the step S18, the printing unit 10 prints a reverse side of the fourth document P4. Then, in the step S19, the fourth document P4 is transported from the second passage 40 to the discharge tray 50. Thereafter, the printing ends.

In the above-mentioned example, the fourth document is transported partially out of the upper passage, transported back from the upper passage, and transported out of the lower passage. In another example, the fourth document may also be transported partially out of the lower passage, transported back from the lower passage and transported out of the lower passage. Because the document travels along the lower passage when being transported partially out, back and out, the transporting style of the fourth document is different from that of the first document. Therefore, if the user is eager to retrieve the documents, then he or she can easily recognize that printing is nearing completion and wait briefly nearby. In other words, with such the arrangement, when the user observes that the document has been temporarily transported out and then back along the lower passage (but not the upper passage) and no other document is pulled back while the document is been transported out (there is no condition where two documents are concurrently present in the upper and lower passages), the user can realize that this is the last document to be printed. Therefore, the user only needs to wait for the fourth document to be reversed and printed on the second side (reverse side), and then the user can take the entire stack of printed documents. That is, according to the control method of another modified example, after the printing unit 10 has printed the front side of the fourth document P4, the fourth document P4 is transported, from the second passage 40, partially out and then back to the reverse passage 30. After the printing unit 10 has printed the reverse side of the fourth document P4, the fourth document P4 is transported from the second passage 40 to the discharge tray 50.

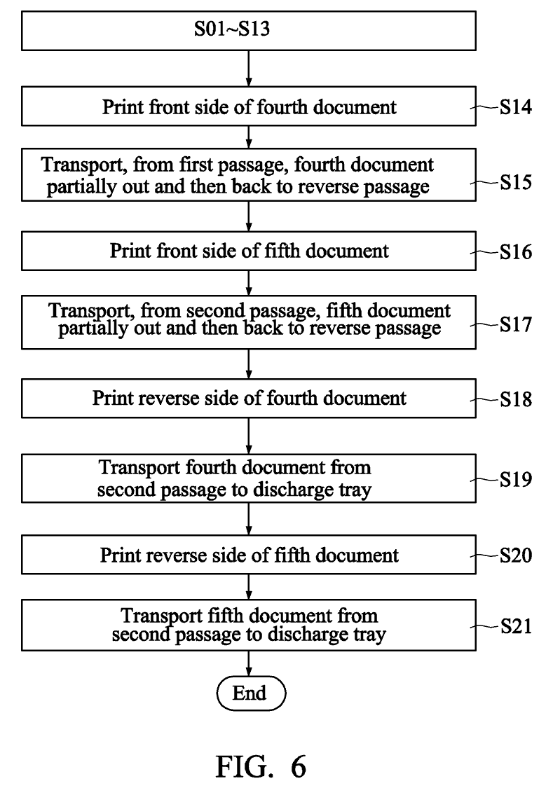

FIG. 6 is a flow chart showing another modified example of the multi-page circulating duplex printing method of FIG. 4. There is a fourth document and a fifth document remained after the step S01, in which the first to third documents are grouped as one set. In this case, the method further includes steps S14 to S21 after the third document P3 has been transported to the discharge tray 50.

In the step S14, the printing unit 10 prints the front side of the fourth document P4. Then, in the step S15, the fourth document P4 is transported, from the first passage 20, partially out and then back to the reverse passage 30.

In the step S16, the printing unit 10 prints a front side of the fifth document P5. Then, in the step S17, the fifth document P5 is transported, from the second passage 40, partially out and then back to the reverse passage 30.

In the step S18, the printing unit 10 prints the reverse side of the fourth document P4. Then, in the step S19, the fourth document P4 is transported from the second passage 40 to the discharge tray 50.

In the step S20, the printing unit 10 prints a reverse side of the fifth document P5. Then, in the step S21, the fifth document P5 is transported from the second passage 40 to the discharge tray 50. Then, the printing ends. So, it is concluded that another document or other documents, other than the first to third documents, are printed only after the third document has been transported from the second passage to the discharge tray

With the multi-page circulating duplex printing method according to the embodiment, the originally designed optimum passage length can be utilized to let multiple documents enter and be printed by the duplex printer. Controlling the timing of transporting the documents out and back can increase the duplex printing speed. For example, a duplex printer with a simplex printing speed that can reach 30 PPM upon single-sided printing also has the theoretical printing speed that can reach 30 IPM. According to the three-page circulating duplex printing method of the embodiment, the printer has the actual speed that can reach 24 IPM (significantly exceeding the prior-art speed of 15 IPM) upon duplex printing.

The specific embodiments proposed in the detailed description of this disclosure are only used to facilitate the description of the technical contents of this disclosure, and do not narrowly limit this disclosure to the above-mentioned embodiments. Various changes of implementations made without departing from the spirit of this disclosure and the scope of the claims are deemed as falling within the following claims.

1. A multi-page circulating duplex printing method used in a duplex printer, the multi-page circulating duplex printing method comprising, in order, steps of:
printing a front side of a first document using a printing unit, and then transporting, from a first passage, the first document partially out and then back to a reverse passage;
printing a front side of a second document using the printing unit, and then transporting, from a second passage, the second document partially out and then back to the reverse passage;
printing a front side of a third document using the printing unit, and then transporting, from the first passage, the third document partially out and then back to the reverse passage;
printing a reverse side of the first document using the printing unit, and then transporting, from the second passage, the first document to a discharge tray;
printing a reverse side of the second document using the printing unit, and then transporting, from the second passage, the second document to the discharge tray; and
printing a reverse side of the third document using the printing unit, and then transporting, from the second passage, the third document to the discharge tray, wherein another document or other documents, other than the first document, the second document and the third document, are printed only after the third document has been transported from the second passage to the discharge tray.

2. The multi-page circulating duplex printing method according to claim 1, wherein a timing of transporting the first document back to the reverse passage overlaps with a timing of transporting the second document to the second passage.

3. The multi-page circulating duplex printing method according to claim 1, wherein a timing of transporting the third document back to the reverse passage overlaps with a timing of transporting the first document to the discharge tray.

4. The multi-page circulating duplex printing method according to claim 1, wherein a first interval is present between a timing of transporting the second document back to the reverse passage and a timing of transporting, from the first passage, the third document partially out, a second interval is present between a timing of transporting the first document to the discharge tray and a timing of transporting the second document to the discharge tray, and a third interval is present between the timing of transporting the second document to the discharge tray and a timing of transporting the third document to the discharge tray.

5. The multi-page circulating duplex printing method according to claim 1, wherein the first document, the second document and the third document are concurrently present, in a time period, in a print passage, including the first passage, the second passage and the reverse passage, other than a supply tray of the duplex printer.

6. The multi-page circulating duplex printing method according to claim 1, wherein:
a total number of print documents corresponding to a print signal are printed in a manner of grouping three ones of the print documents into one set.

7. The multi-page circulating duplex printing method according to claim 1, further comprising, after the third document has been transported to the discharge tray, steps of:
printing a front side of a fourth document using the printing unit, and then transporting, from the first passage, the fourth document partially out and then back to the reverse passage;
printing a reverse side of the fourth document using the printing unit, and then transporting the fourth document from the second passage to the discharge tray; and
ending printing.

8. The multi-page circulating duplex printing method according to claim 1, further comprising:
printing a front side of a fourth document using the printing unit, and then transporting, from the second passage, the fourth document partially out and then back to the reverse passage;
printing a reverse side of the fourth document using the printing unit, and then transporting the fourth document from the second passage to the discharge tray; and
ending printing.

9. The multi-page circulating duplex printing method according to claim 1, further comprising, after the third document has been transported to the discharge tray, steps of:
printing a front side of a fourth document using the printing unit, and then transporting, from the first passage, the fourth document partially out and then back to the reverse passage;
printing a front side of a fifth document using the printing unit, and then transporting, from the second passage, the fifth document partially out and then back to the reverse passage;
printing a reverse side of the fourth document using the printing unit, and then transporting the fourth document from the second passage to the discharge tray;
printing a reverse side of the fifth document using the printing unit, and then transporting the fifth document from the second passage to the discharge tray; and
ending printing.

10. The multi-page circulating duplex printing method according to claim 1, wherein the duplex printer is a color duplex printer.
